(19) United States
(12) Patent Application Publication
(10) Pub. No.: US 2024/0421910 A1
(43) Pub. Date: Dec. 19, 2024

(54) OPTICAL TRANSMITTING APPARATUS, OPTICAL TRANSMITTING METHOD AND OPTICAL TRANSMISSION SYSTEM

(71) Applicant: NIPPON TELEGRAPH AND TELEPHONE CORPORATION, Tokyo (JP)

(72) Inventors: Toshiaki SHITABA, Musashino-shi, Tokyo (JP); Tomoaki YOSHIDA, Musashino-shi, Tokyo (JP); Yoichi FUKADA, Musashino-shi, Tokyo (JP); Akihiro TANABE, Musashino-shi, Tokyo (JP); Ryo MIYATAKE, Musashino-shi, Tokyo (JP)

(73) Assignee: NIPPON TELEGRAPH AND TELEPHONE CORPORATION, Tokyo (JP)

(21) Appl. No.: 18/274,148

(22) PCT Filed: Feb. 10, 2021
(86) PCT No.: PCT/JP2021/005116

§ 371 Date: Jul. 25, 2023

(51) Int. Cl. H04B 10/516; H04J 14/02

(52) U.S. Cl. CPC H04B 10/5161; H04J 14/0298

(57) ABSTRACT

An optical transmission apparatus includes: a distributing unit which distributes a laser beam based on a first oscillation frequency; a phase modulator which generates, using the laser beam based on the first oscillation frequency, a phase-modulated signal that is an optical signal phase-modulated in accordance with a modulated signal; a multiplexing unit which multiplexes a laser beam based on a second oscillation frequency and the phase-modulated signal; a detecting unit which generates a frequency-modulated signal by performing detection processing on a result of multiplexing of the laser beam based on the second oscillation frequency and the phase-modulated signal; and an intensity modulator which generates, using the laser beam based on the first oscillation frequency, an optical signal intensity-modulated in accordance with the frequency-modulated signal.

### DESCRIPTION

### Technical Field

The present invention relates to an optical transmission apparatus, an optical transmission method, and an optical transmission system.

### Background Art

An optical transmission system adopting a method of performing batch conversion of frequency division multiplexing (FDM) signals into frequency modulation (FM) signals (hereinafter, referred to as an “FM batch conversion method”) has been introduced into video signal distribution systems (refer to NPL 1 and 2).

FIG. 7 is a diagram showing a first example of a configuration of an optical transmission apparatus in such an optical transmission system. An optical transmission apparatus 10a includes a frequency modulating unit 100a, a laser oscillator 110, and an intensity modulator 120. The frequency modulating unit 100a includes a first laser oscillator 101, a second laser oscillator 102, a phase modulator 103, a multiplexing unit 104, and a detecting unit 105.

The first laser oscillator 101 is a laser diode. The first laser oscillator 101 generates a laser beam based on a first oscillation frequency “f1”. A video signal (modulated signal) of cable television broadcasting in a frequency-multiplexed signal is input to the first laser oscillator 101 from a head-end apparatus (not shown). The first laser oscillator 101 generates, using the laser beam based on the first oscillation frequency “f1”, an optical signal directly modulated in accordance with the video signal of cable television broadcasting.

The second laser oscillator 102 is a laser diode. The second laser oscillator 102 generates a laser beam based on a second oscillation frequency “f2”. Hereinafter, a video signal of which a phase has been inverted will be referred to as an “opposite phase video signal”. A video signal of an opposite phase to that of cable television broadcasting in the frequency-multiplexed signal is input to the second laser oscillator 102 from the head-end apparatus (not shown). The second laser oscillator 102 generates, using the laser beam based on the second oscillation frequency “f2”, an optical signal directly modulated in accordance with the opposite phase video signal.

An optical signal having been directly modulated in accordance with the video signal of cable television broadcasting is input to the phase modulator 103 from the first laser oscillator 101. In addition, a satellite broadcasting video signal (modulated signal) in the frequency-multiplexed signal is input to the phase modulator 103 from the head-end apparatus (not shown).

The phase modulator 103 modulates, in accordance with the video signal of satellite broadcasting, the phase of the optical signal having been directly modulated in accordance with the video signal of cable television broadcasting. The phase modulator 103 outputs the phase-modulated optical signal (phase-modulated signal) to the multiplexing unit 104.

The phase-modulated optical signal is input to the multiplexing unit 104 from the phase modulator 103. Furthermore, an optical signal directly modulated in accordance with the opposite phase video signal is input to the multiplexing unit 104 from the second laser oscillator 102. The multiplexing unit 104 multiplexes the phase-modulated optical signal and the optical signal directly modulated in accordance with the opposite phase video signal.

The detecting unit 105 uses a photodiode to perform batch reception processing (optical heterodyne detection) on the multiplexed optical signal. Accordingly, the detecting unit 105 generates a frequency-modulated signal having high linearity. A center frequency of the frequency-modulated signal is “|f1−f2|”. The detecting unit 105 outputs the frequency-modulated signal to the intensity modulator 120.

The laser oscillator 110 generates a laser beam for transmission based on a predetermined oscillation frequency. The intensity modulator 120 is a device for performing intensity modulation on the laser beam for transmission in accordance with a frequency-modulated signal. The intensity modulator 120 generates, using the laser beam for transmission, an intensity-modulated optical signal. The intensity modulator 120 transmits the intensity-modulated optical signal to a V-OLT (Video-Optical Line Terminal).

As described above, in the FM batch conversion system, a frequency modulating unit generates, using two laser beams, an optical signal directly modulated in accordance with an input video signal (modulated signal). Very high linearity is required for characteristics between a bias current and an oscillation frequency in the two laser beams. Therefore, there is a problem that a selection cost of each laser oscillator is very high. In order to solve this problem, conceivably, after connecting a phase modulator to a subsequent stage of one of the two laser oscillators, all video signals to be transmitted are input to the phase modulator.

FIG. 8 is a diagram showing a second example of a configuration of a conventional optical transmission apparatus. An optical transmission apparatus 10b includes a frequency modulating unit 100b, the laser oscillator 110, and the intensity modulator 120. The frequency modulating unit 100b includes the first laser oscillator 101, the second laser oscillator 102, the phase modulator 103, the multiplexing unit 104, the detecting unit 105, and an amplifying unit 106.

The first laser oscillator 101 generates a laser beam based on a first oscillation frequency “f1”. The first laser oscillator 101 outputs the laser beam based on the first oscillation frequency “f1” to the phase modulator 103. The second laser oscillator 102 generates a laser beam based on a second oscillation frequency “f2”. The second laser oscillator 102 outputs the laser beam based on the second oscillation frequency “f2” to the multiplexing unit 104.

A video signal of cable television broadcasting and a video signal of satellite broadcasting are input to the amplifying unit 106 as a frequency-multiplexed signal from a head-end apparatus (not shown). An amplifying unit 116 amplifies the voltage of these video signals to about several volts to obtain a sufficient frequency deviation amount in the frequency-modulated signal. The amplifying unit 106 outputs the video signal of which voltage has been amplified to the phase modulator 103.

The phase modulator 103 generates, using the laser beam based on the first oscillation frequency “f1”, an optical signal phase-modulated using the video signal of which voltage has been amplified. The phase-modulated optical signal is input to the multiplexing unit 104 from the phase modulator 103. In addition, the laser beam based on the second oscillation frequency “f2” is input to the multiplexing unit 104 from the second laser oscillator 102.

The multiplexing unit 104 multiplexes the phase-modulated optical signal and the laser beam based on the second oscillation frequency “f2”. The detecting unit 105 uses a photodiode to perform batch reception processing (optical heterodyne detection) on the multiplexed optical signal. The detecting unit 105 outputs the frequency-modulated signal to the intensity modulator 120. The laser oscillator 110 generates a laser beam for transmission based on a predetermined oscillation frequency. The intensity modulator 120 generates, using the laser beam for transmission generated by the laser oscillator 110, an optical signal intensity-modulated in accordance with the frequency-modulated signal.

### CITATION LIST

### Non Patent Literature

[NPL 1] ITU-T J.185: Transmission equipment for transferring multi-channel television signals over optical access networks by frequency modulation conversion, [online], [retrieved on Aug. 21, 2020], the Internet <URL: https://www.itu.int/rec/T-REC-J.185-201206-I/en>

[NPL 2] Toshiaki Shitaba, et al., “Optical Video Transmission Technique using FM conversion,” IEICE Technical Report CS2019-84, IE2019-64 (2019-12), [online], [retrieved on Jan. 25, 2021], the Internet <URL: https://www.ieice.org/ken/paper/20191206T1TI/>

### SUMMARY OF INVENTION

### Technical Problem

As illustrated in FIGS. 7 and 8, the conventional optical transmission apparatus includes at least one laser oscillator for generating a laser beam for transmission in addition to the first laser oscillator and the second laser oscillator for generating a frequency-modulated signal. In this manner, the conventional optical transmission apparatus has a problem in that an intensity-modulated optical signal cannot be transmitted unless the optical transmission apparatus is provided with a laser oscillator separate from the two laser oscillators for generating a frequency-modulated signal.

In view of the circumstances described above, an object of the present invention is to provide an optical transmission apparatus, an optical transmission method, and an optical transmission system capable of transmitting an intensity-modulated optical signal even when there is no laser oscillator separate from two laser oscillators for generating a frequency-modulated signal.

### Solution to Problem

An aspect of the present invention is an optical transmission apparatus including: a distributing unit which distributes a laser beam based on a first oscillation frequency; a phase modulator which generates, using the laser beam based on the first oscillation frequency, a phase-modulated signal that is an optical signal phase-modulated in accordance with a modulated signal; a multiplexing unit which multiplexes a laser beam based on a second oscillation frequency and the phase-modulated signal; a detecting unit which generates a frequency-modulated signal by performing detection processing on a result of multiplexing of the laser beam based on the second oscillation frequency and the phase-modulated signal; and an intensity modulator which generates, using the laser beam based on the first oscillation frequency, an optical signal intensity-modulated in accordance with the frequency-modulated signal.

An aspect of the present invention is an optical transmission apparatus including: a phase modulator which generates, using a laser beam based on a first oscillation frequency, a phase-modulated signal that is an optical signal phase-modulated in accordance with a modulated signal; a distributing unit which distributes a laser beam based on a second oscillation frequency; a multiplexing unit which multiplexes the laser beam based on the second oscillation frequency and the phase-modulated signal; a detecting unit which generates a frequency-modulated signal by performing detection processing on a result of multiplexing of the laser beam based on the second oscillation frequency and the phase-modulated signal; and an intensity modulator which generates, using the laser beam based on the second oscillation frequency, an optical signal intensity-modulated in accordance with the frequency-modulated signal.

An aspect of the present invention is an optical transmission method executed by an optical transmission apparatus, including the steps of: distributing a laser beam based on a first oscillation frequency; generating, using the laser beam based on the first oscillation frequency, a phase-modulated signal that is an optical signal phase-modulated in accordance with a modulated signal; multiplexing a laser beam based on a second oscillation frequency and the phase-modulated signal; generating a frequency-modulated signal by performing detection processing on a result of multiplexing of the laser beam based on the second oscillation frequency and the phase-modulated signal; and generating, using the laser beam based on the first oscillation frequency, an optical signal intensity-modulated in accordance with the frequency-modulated signal.

An aspect of the present invention is an optical transmission method executed by an optical transmission apparatus, including the steps of: generating, using a laser beam based on a first oscillation frequency, a phase-modulated signal that is an optical signal phase-modulated in accordance with a modulated signal; distributing a laser beam based on a second oscillation frequency; multiplexing the laser beam based on the second oscillation frequency and the phase-modulated signal; generating a frequency-modulated signal by performing detection processing on a result of multiplexing of the laser beam based on the second oscillation frequency and the phase-modulated signal; and generating, using the laser beam based on the second oscillation frequency, an optical signal intensity-modulated in accordance with the frequency-modulated signal.

An aspect of the present invention is an optical transmission system including an optical transmission apparatus, an optical line terminal, and an optical network unit, wherein the optical transmission apparatus includes: a distributing unit which distributes a laser beam based on a first oscillation frequency; a phase modulator which generates, using the laser beam based on the first oscillation frequency, a phase-modulated signal that is an optical signal phase-modulated in accordance with a modulated signal; a multiplexing unit which multiplexes a laser beam based on a second oscillation frequency and the phase-modulated signal; a detecting unit which generates a frequency-modulated signal by performing detection processing on a result of multiplexing of the laser beam based on the second oscillation frequency and the phase-modulated signal; and an intensity modulator which generates, using the laser beam based on the first oscillation frequency, an optical signal intensity-modulated in accordance with the frequency-modulated signal, the optical line terminal transmits the intensity-modulated optical signal, and the optical network unit acquires the intensity-modulated optical signal.

An aspect of the present invention is an optical transmission system including an optical transmission apparatus, an optical line terminal, and an optical network unit, wherein the optical transmission apparatus includes: a phase modulator which generates, using a laser beam based on a first oscillation frequency, a phase-modulated signal that is an optical signal phase-modulated in accordance with a modulated signal; a distributing unit which distributes a laser beam based on a second oscillation frequency; a multiplexing unit which multiplexes the laser beam based on the second oscillation frequency and the phase-modulated signal; a detecting unit which generates a frequency-modulated signal by performing detection processing on a result of multiplexing of the laser beam based on the second oscillation frequency and the phase-modulated signal; and an intensity modulator which generates, using the laser beam based on the second oscillation frequency, an optical signal intensity-modulated in accordance with the frequency-modulated signal, the optical line terminal transmits the intensity-modulated optical signal, and the optical network unit acquires the intensity-modulated optical signal.

### Advantageous Effects of Invention

According to the present invention, an intensity-modulated optical signal can be transmitted even when there is no laser oscillator separate from two laser oscillators for generating a frequency-modulated signal.

### BRIEF DESCRIPTION OF DRAWINGS

FIG. 1 is a diagram showing a configuration example of an optical transmission system according to a first embodiment.

FIG. 2 is a diagram showing a configuration example of an optical transmission apparatus according to the first embodiment.

FIG. 3 is a flowchart showing an operation example of the optical transmission apparatus according to the first embodiment.

FIG. 4 is a diagram showing a configuration example of an optical transmission system according to a second embodiment.

FIG. 5 is a diagram showing a configuration example of an optical transmission apparatus according to the second embodiment.

FIG. 6 is a flowchart showing an operation example of the optical transmission apparatus according to the second embodiment.

FIG. 7 is a diagram showing a first example of a configuration of a conventional optical transmission apparatus.

FIG. 8 is a diagram showing a second example of a configuration of a conventional optical transmission apparatus.

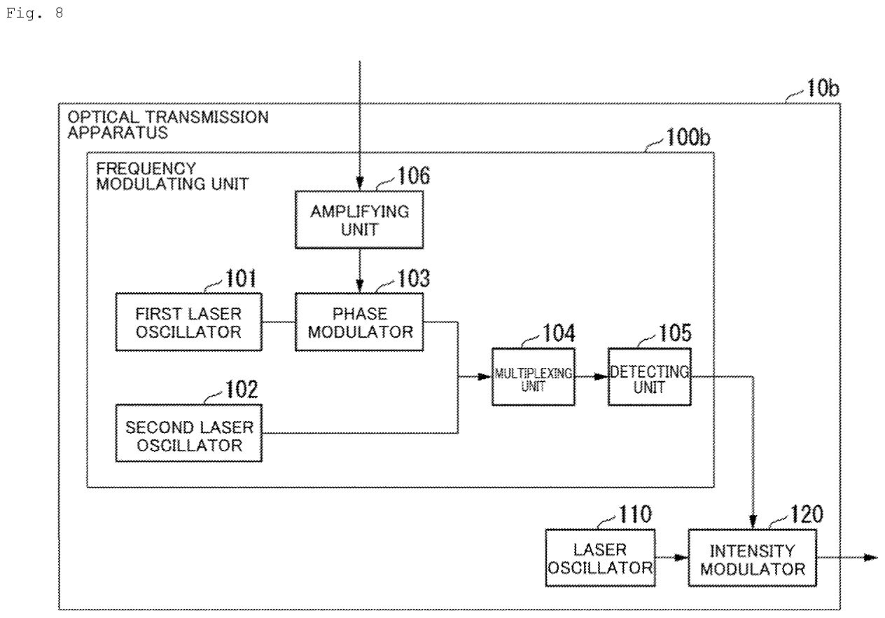

### DESCRIPTION OF EMBODIMENTS

Embodiments of the present invention will be described in detail with reference to the drawings.

### First Embodiment

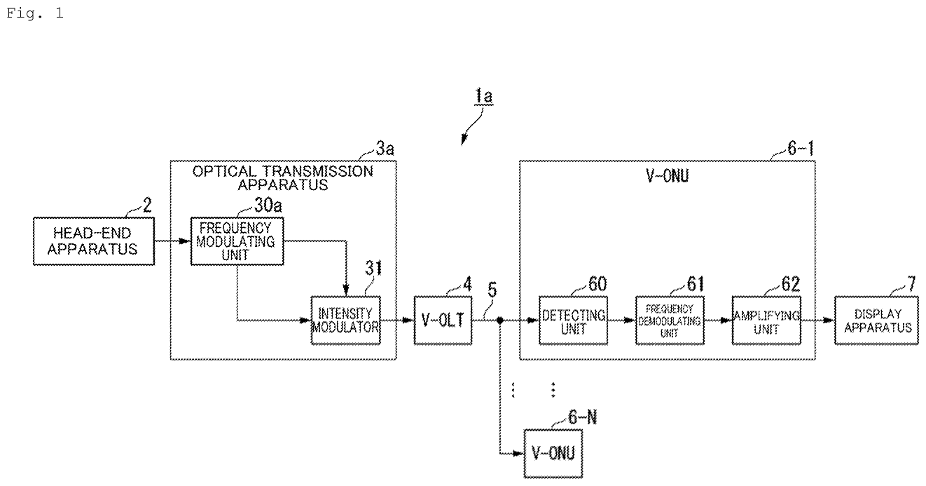

FIG. 1 is a diagram showing a configuration example of an optical transmission system 1a. The optical transmission system 1a is a system (optical transmission network) for transmitting an optical signal. In the following description, as an example, an optical transmission system distributes a video signal using an optical signal. A video may be a moving image or a still image.

The optical transmission system 1a includes a head-end apparatus 2, an optical transmission apparatus 3a, a V-OLT 4, a transmission path 5, N-number (where N is an integer of 1 or more) of V-ONUs 6, and a display apparatus 7. The optical transmission apparatus 3a includes a frequency modulating unit 30a and an intensity modulator 31. Each V-ONU 6 includes a detecting unit 60, a frequency demodulating unit 61, and an amplifying unit 62.

The head-end apparatus 2 outputs a frequency-multiplexed signal including a video signal (modulated signal) to the optical transmission apparatus 3a. Note that the head-end apparatus 2 may output a frequency-multiplexed signal including an audio signal, a data signal or the like (modulated signal), and a video signal to the optical transmission apparatus 3a.

The optical transmission apparatus 3a is an apparatus which transmits an optical signal. The frequency modulating unit 30a performs, for example, optical heterodyne detection processing on an optical beat between an optical signal having been phase-modulated in accordance with a video signal and an optical signal having been phase-modulated in accordance with an opposite phase video signal. Accordingly, the frequency modulating unit 30a generates a frequency-modulated signal (FM signal).

The optical transmission apparatus 3a generates a laser beam for transmission based on a first oscillation frequency “f1”. The intensity modulator 31 executes intensity modulation on the laser beam for transmission in accordance with the frequency-modulated signal generated by the frequency modulating unit 30a. Accordingly, the intensity modulator 31 generates, using the laser beam for transmission, an intensity-modulated optical signal. The intensity modulator 31 transmits the intensity-modulated optical signal to the V-OLT 4.

The V-OLT 4 is an optical line terminal. The V-OLT 4 transmits the optical signal intensity-modulated by the intensity modulator 31 to each V-ONU 6 via the transmission path 5. The transmission path 5 transmits an optical signal using an optical fiber. The transmission path 5 distributes an optical signal to each V-ONU 6 from V-ONU 6-1 to V-ONU 6-N using an optical splitter.

Each V-ONU 6 (Video-Optical Network Unit) is an optical network unit. The detecting unit 60 has a photodiode. The detecting unit 60 converts an optical signal acquired via the transmission path 5 into a frequency-modulated signal (electric signal). The frequency demodulating unit 61 generates a frequency-multiplexed signal including a video signal by performing demodulation processing on the frequency-modulated signal. The demodulation processing includes processing of detecting a rise of the frequency-modulated signal and processing of detecting a fall of the frequency-modulated signal. The amplifying unit 62 amplifies voltage of the video signal in the frequency-multiplexed signal to a predetermined level.

The display apparatus 7 is an apparatus which displays a video on a screen. The display apparatus 7 acquires a frequency-multiplexed signal including a video signal of which voltage has been amplified to a predetermined level from the amplifying unit 62. The display apparatus 7 displays a video on a screen in accordance with the video signal in the frequency-multiplexed signal.

Next, a configuration example of the optical transmission apparatus 3a will be described.

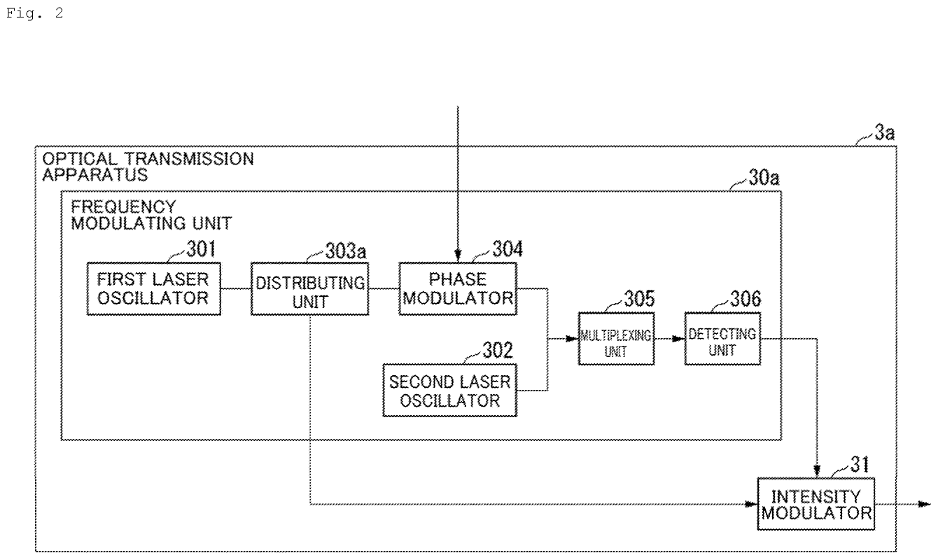

FIG. 2 is a diagram showing a configuration example of the optical transmission apparatus 3a. The optical transmission apparatus 3a includes the frequency modulating unit 30a and the intensity modulator 31. The frequency modulating unit 30a includes a first laser oscillator 301, a second laser oscillator 302, a distributing unit 303a, a phase modulator 304, a multiplexing unit 305, and a detecting unit 306.

In FIG. 2, the first laser oscillator 301 is connected to the distributing unit 303a so that an output of the first laser oscillator 301 is input to the distributing unit 303a. In addition, the second laser oscillator 302 is connected to the multiplexing unit 305 so that an output of the second laser oscillator 302 is input to the multiplexing unit 305.

In FIG. 2, the distributing unit 303a is connected to the phase modulator 304 so that a first output of the distributing unit 303a is input to the phase modulator 304. In addition, the distributing unit 303a is connected to the intensity modulator 31 so that a second output of the distributing unit 303a is input to the intensity modulator 31.

The first laser oscillator 301 is a laser diode. The first laser oscillator 301 outputs a laser beam based on the first oscillation frequency “f1” to the distributing unit 303a. The laser beam based on the first oscillation frequency “f1” is utilized for generating a phase-modulated optical signal in the phase modulator 304.

The second laser oscillator 302 is a laser diode. The second laser oscillator 302 generates a laser beam on the basis of the second oscillation frequency “f2”. The second laser oscillator 302 outputs the laser beam based on the second oscillation frequency “f2” to the multiplexing unit 305.

The laser beam based on the first oscillation frequency “f1” is input to the distributing unit 303a from the first laser oscillator 301. The distributing unit 303a distributes the laser beam based on the first oscillation frequency “f1” to the phase modulator 304 and the intensity modulator 31. In the first embodiment, the laser beam based on the first oscillation frequency “f1” is utilized in the intensity modulator 31 to generate an optical signal for output.

A frequency-multiplexed signal including a video signal (modulated signal) is input to the phase modulator 304 from the head-end apparatus 2 as an input signal. In the following description, video signals are, for example, video signals of cable television broadcasting and video signals (intermediate frequency (IF) signals) of satellite broadcasting.

For example, video signals of cable television broadcasting include an AM (Amplitude Modulation) signal for analog broadcasting and a QAM (Quadrature Amplitude Modulation) signal for digital broadcasting which are included in a band from 70 MHz to 770 MHz. For example, video signals of satellite broadcasting include a BS (Broadcast Satellite) signal and a CS (Communication Satellite) 110-degrees signal which are included in a band from 1.0 GHZ to 2.1 GHZ.

The laser beam based on the first oscillation frequency “f1” is input to the phase modulator 304 from the distributing unit 303a. The phase modulator 304 performs phase modulation on the laser beam based on the first oscillation frequency “f1” in accordance with a video signal. In other words, the phase modulator 304 generates, using the laser beam based on the first oscillation frequency “f1”, an optical signal phase-modulated in accordance with the video signal. The phase modulator 304 outputs the optical signal phase-modulated in accordance with the video signal to the multiplexing unit 305.

The optical signal phase-modulated in accordance with the video signal is input to the multiplexing unit 305 from the phase modulator 304. The laser beam based on the second oscillation frequency “f2” is input to the multiplexing unit 305 from the second laser oscillator 302. The multiplexing unit 305 multiplexes the optical signal phase-modulated in accordance with the video signal and the laser beam based on the second oscillation frequency “f2”. The multiplexing unit 305 outputs the multiplexed optical signal to the detecting unit 306.

The detecting unit 306 has a photodiode. The detecting unit uses the photodiode 306 to execute batch reception processing (for example, optical heterodyne detection processing) on the multiplexed optical signal. Accordingly, the detecting unit 306 generates a frequency-modulated signal (FM signal) of a wide band. A center frequency of the frequency-modulated signal is “|f1−f2|”. The detecting unit 306 outputs the frequency-modulated signal of a wide band (for example, 500 MHz to 6 GHZ) to the intensity modulator 31.

The laser beam (a laser beam for transmission) based on the first oscillation frequency “f1” is input to the intensity modulator 31 from the distributing unit 303a. The wide-band frequency-modulated signal is input to the intensity modulator 31 from the detecting unit 306. The intensity modulator 31 performs intensity modulation on the laser beam for transmission distributed by the distributing unit 303a in accordance with the frequency-modulated signal generated by the detecting unit 306. Accordingly, the intensity modulator 31 generates, using the laser beam for transmission, an intensity-modulated optical signal (an optical signal for output). The intensity modulator 31 transmits the intensity-modulated optical signal to the V-OLT 4.

Next, an operation example of the optical transmission apparatus 3a will be described.

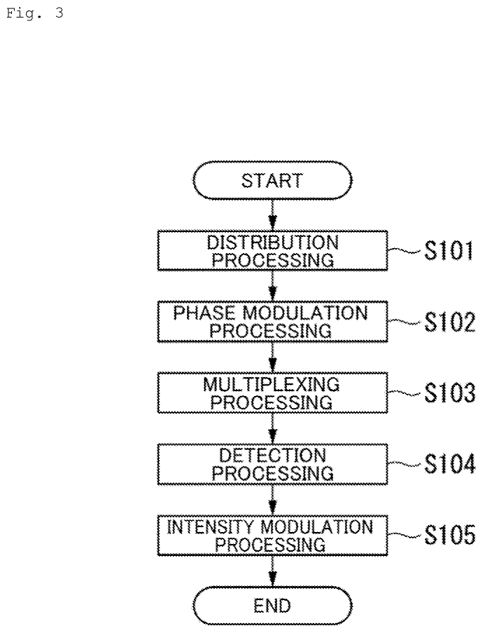

FIG. 3 is a flowchart showing an operation example of the optical transmission apparatus 3a. The distributing unit 303a distributes a laser beam based on the first oscillation frequency “f1” to the phase modulator 304 and the intensity modulator 31. In other words, the first laser oscillator 301 uses the distributing unit 303a to output a laser beam based on the first oscillation frequency “f1” to the phase modulator 304 and the intensity modulator 31 (step S101).

The phase modulator 304 generates, using the laser beam based on the first oscillation frequency “f1”, an optical signal phase-modulated in accordance with a video signal. The phase modulator 304 outputs the optical signal phase-modulated in accordance with the video signal to the multiplexing unit 305 (step S102).

The multiplexing unit 305 multiplexes the optical signal phase-modulated in accordance with the video signal and a laser beam based on the second oscillation frequency “f2” (step S103). The detecting unit 306 generates a frequency-modulated signal by executing batch reception processing with respect to a result of multiplexing of the optical signal phase-modulated in accordance with the video signal and the laser beam based on the second oscillation frequency “f2” (step S104).

The intensity modulator 31 performs intensity modulation on a laser beam for transmission generated by the second laser oscillator 302 in accordance with the frequency-modulated signal generated by the detecting unit 306. Accordingly, the intensity modulator 31 generates, using the laser beam for transmission, an intensity-modulated optical signal (step S105).

As described above, the distributing unit 303a distributes a laser beam based on a first oscillation frequency “f1” to the phase modulator 304 and the intensity modulator 31. The phase modulator 304 generates, using the laser beam based on the first oscillation frequency “f1”, a phase-modulated signal which is an optical signal phase-modulated in accordance with a modulated signal (for example, a video signal). The multiplexing unit 305 multiplexes a laser beam based on a second oscillation frequency “f2” and the phase-modulated signal. The detecting unit 306 generates a frequency-modulated signal by performing detection processing on a result of multiplexing of the laser beam based on the second oscillation frequency “f2” and the phase-modulated signal. The intensity modulator 31 generates, using the laser beam based on the first oscillation frequency “f1”, an optical signal intensity-modulated in accordance with the frequency-modulated signal. The V-OLT 4 (optical line terminal) may transmit the intensity-modulated optical signal. The V-ONU 6 (optical network unit) may acquire the intensity-modulated optical signal.

Accordingly, even when there is no laser oscillator separate from two laser oscillators for generating a frequency-modulated signal, an intensity-modulated optical signal can be transmitted.

The laser oscillator is a component requiring a power supply or, in other words, a component (active component) that operates when energized. For this reason, the laser oscillator may fail due to aging. On the other hand, the optical transmission apparatus 3a is not provided with a laser oscillator separate from the first laser oscillator 301 and the second laser oscillator 302 for generating a frequency-modulated signal. Therefore, the optical transmission apparatus 3a has a low failure rate and high reliability. In addition, the optical transmission apparatus 3a is small-sized and low cost.

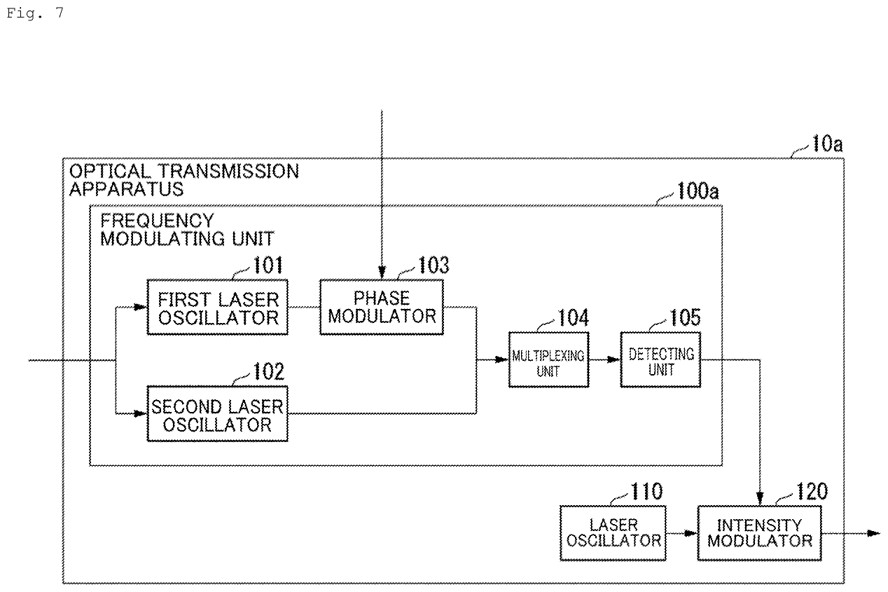

In the conventional optical transmission apparatus 10a shown in FIG. 7, an optical signal directly modulated in accordance with a video signal of cable television broadcasting is further phase-modulated in accordance with a video signal (frequency-modulated signal) of satellite broadcasting. Therefore, supposing that the optical transmission apparatus 10a does not include the laser oscillator 110 and a laser beam of the second laser oscillator 102 is input to the intensity modulator 120, a waveform of an optical signal for output is apt to be disturbed. On the other hand, in the optical transmission apparatus 3a according to the first embodiment, since the phase modulator 103 performs phase modulation of a laser beam in accordance with the video signals of all channels (cable television broadcasting and satellite broadcasting), the waveform of the optical signal for output is hardly disturbed even when a laser oscillator separate from the first laser oscillator 301 and the second laser oscillator 302 is not provided.

### Second Embodiment

A second embodiment differs from the first embodiment in that a laser beam based on a second oscillation frequency “f2” is used for generating an optical signal for output. The description of the second embodiment will focus on differences from the first embodiment.

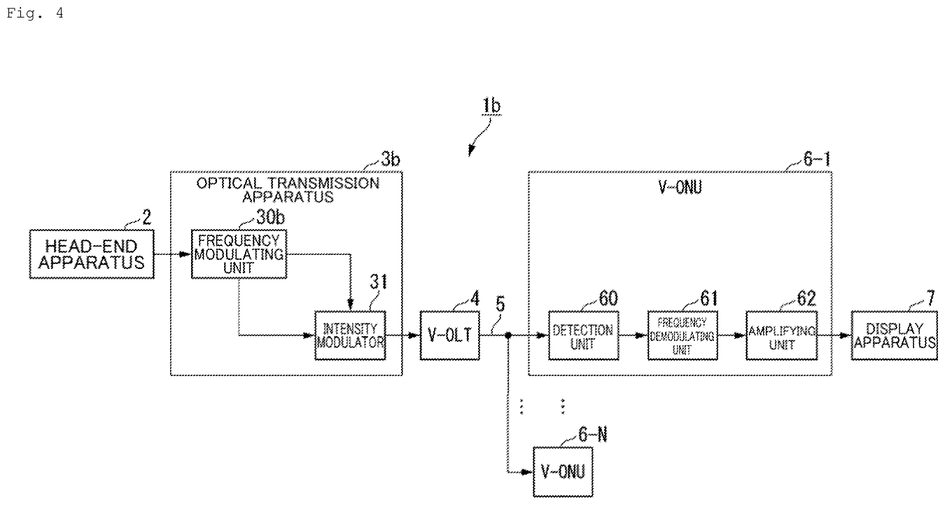

FIG. 4 is a diagram showing a configuration example of an optical transmission system 1b. The optical transmission system 1b is a system (optical transmission network) for transmitting an optical signal. The optical transmission system 1b includes the head-end apparatus 2, an optical transmission apparatus 3b, the V-OLT 4, the transmission path 5, N-number (where N is an integer of 1 or more) of V-ONUs 6, and the display apparatus 7. The optical transmission apparatus 3b includes a frequency modulating unit 30b and the intensity modulator 31.

The optical transmission apparatus 3b is an apparatus which transmits an optical signal. The frequency modulating unit 30b performs, for example, optical heterodyne detection processing on an optical beat between an optical signal having been phase-modulated in accordance with a video signal and an optical signal having been phase-modulated in accordance with an opposite phase video signal. Accordingly, the frequency modulating unit 30b generates a frequency-modulated signal (FM signal).

The frequency modulating unit 30b generates a laser beam for transmission based on a second oscillation frequency “f2”. The intensity modulator 31 performs intensity modulation on the laser beam for transmission in accordance with the frequency-modulated signal generated by the frequency modulating unit 30b. Accordingly, the intensity modulator 31 generates, using the laser beam for transmission, an intensity-modulated optical signal.

Next, a configuration example of the optical transmission apparatus 3b will be described.

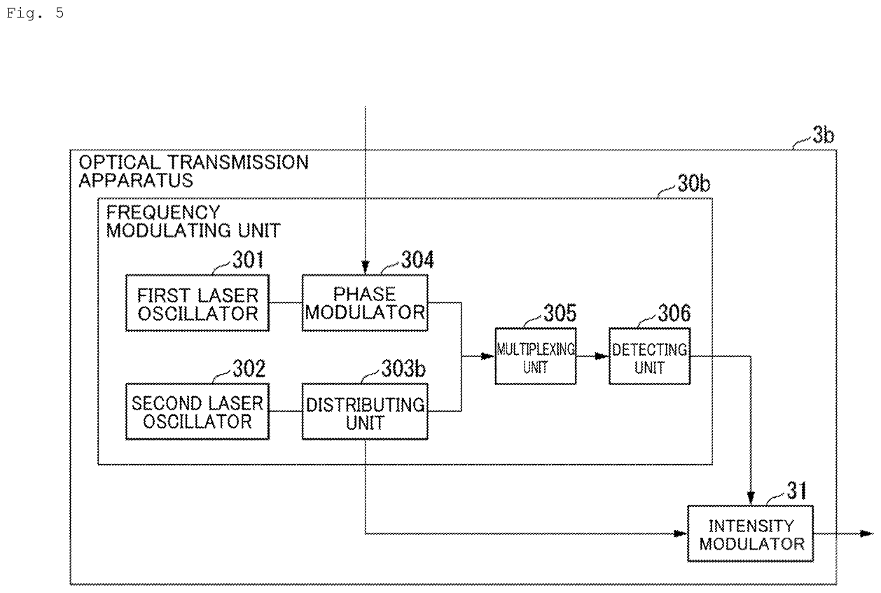

FIG. 5 is a diagram showing a configuration example of the optical transmission apparatus 3b. The optical transmission apparatus 3b includes the frequency modulating unit 30b and the intensity modulator 31. The frequency modulating unit 30b includes the first laser oscillator 301, the second laser oscillator 302, a distributing unit 303b, the phase modulator 304, the multiplexing unit 305, and the detecting unit 306.

In FIG. 5, the first laser oscillator 301 is connected to the phase modulator 304 so that an output of the first laser oscillator 301 is input to the phase modulator 304. In addition, the second laser oscillator 302 is connected to the distributing unit 303b so that an output of the second laser oscillator 302 is input to the distributing unit 303b.

In FIG. 5, the distributing unit 303b is connected to the multiplexing unit 305 so that a first output of the distributing unit 303b is input to the multiplexing unit 305.

In addition, the distributing unit 303b is connected to the intensity modulator 31 so that a second output of the distributing unit 303b is input to the intensity modulator 31.

The first laser oscillator 301 outputs a laser beam based on a first oscillation frequency “f1” to the phase modulator 304. The laser beam based on the first oscillation frequency “f1” is utilized for generating a phase-modulated optical signal in the phase modulator 304.

The second laser oscillator 302 outputs a laser beam based on the second oscillation frequency “f2” to the distributing unit 303b. The laser beam based on the second oscillation frequency “f2” is input to the distributing unit 303b from the second laser oscillator 302. The distributing unit 303b distributes the laser beam based on the second oscillation frequency “f2” to the multiplexing unit 305 and the intensity modulator 31. In the second embodiment, the laser beam based on the second oscillation frequency “f2” is utilized in the intensity modulator 31 to generate an optical signal for output.

An optical signal phase-modulated in accordance with a video signal is input to the multiplexing unit 305 from the phase modulator 304. In addition, the laser beam based on the second oscillation frequency “f2” is input to the multiplexing unit 305 from the distributing unit 303b. The multiplexing unit 305 multiplexes the optical signal phase-modulated in accordance with a video signal and the laser beam based on the second oscillation frequency “f2”. The multiplexing unit 305 outputs the multiplexed optical signal to the detecting unit 306.

The laser beam (a laser beam for transmission) based on the first oscillation frequency “f2” is input to the intensity modulator 31 from the distributing unit 303b. A wide-band frequency-modulated signal is input to the intensity modulator 31 from the detecting unit 306. The intensity modulator 31 performs intensity modulation on the laser beam for transmission by the distributing unit 303b in accordance with the frequency-modulated signal generated by generated by the detecting unit 306. Accordingly, the intensity modulator 31 generates, using the laser beam for transmission, an intensity-modulated optical signal. The intensity modulator 31 transmits the intensity-modulated optical signal to the V-OLT 4.

Next, an operation example of the optical transmission apparatus 3b will be described.

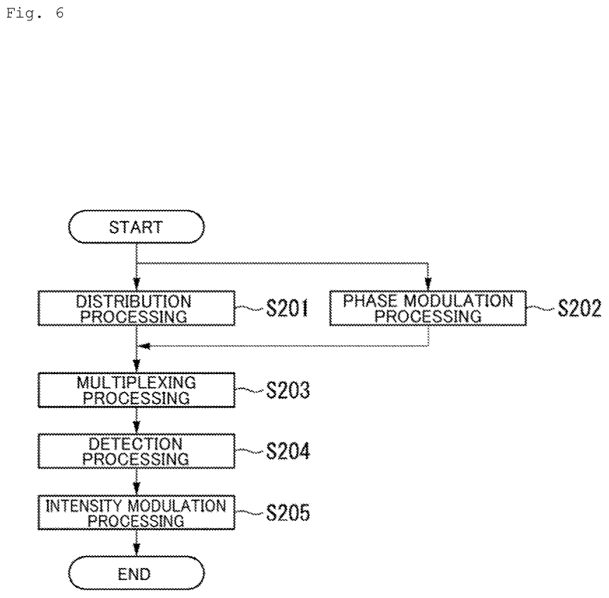

FIG. 6 is a flowchart showing an operation example of the optical transmission apparatus 3b. The distributing unit 303b distributes a laser beam based on the second oscillation frequency “f2” to the multiplexing unit 305 and the intensity modulator 31. In other words, the second laser oscillator 302 outputs the laser beam based on the second oscillation frequency “f2” to the multiplexing unit 305 and the intensity modulator 31 using the distributing unit 303b (step S201).

The phase modulator 304 generates, using a laser beam based on the first oscillation frequency “f1”, an optical signal phase-modulated in accordance with a video signal. The phase modulator 304 outputs the optical signal phase-modulated in accordance with the video signal to the multiplexing unit 305 (step S202).

Step S203 (a step of multiplexing the phase-modulated optical signal and the laser beam) is similar to step S103 shown in FIG. 3. Step S204 (a step of generating a frequency-modulated signal) is similar to step S104 shown in FIG. 3.

The intensity modulator 31 performs intensity modulation on the laser beam for transmission generated by the second laser oscillator 302 in accordance with the frequency-modulated signal generated by the detecting unit 306. Accordingly, the intensity modulator 31 generates, using the laser beam for transmission, an intensity-modulated optical signal (step S205).

As described above, the phase modulator 304 generates, using a laser beam based on the first oscillation frequency “f1”, a phase-modulated signal which is an optical signal phase-modulated in accordance with a modulated signal. The distributing unit 303b distributes a laser beam based on the second oscillation frequency “f2” to the multiplexing unit 305 and the intensity modulator 31. The multiplexing unit 305 multiplexes the laser beam based on the second oscillation frequency “f2” and the phase-modulated signal. The detecting unit 306 generates a frequency-modulated signal by performing detection processing on a result of multiplexing of the laser beam based on the second oscillation frequency “f2” and the phase-modulated signal. The intensity modulator 31 generates, using the laser beam based on the second oscillation frequency “f2”, an optical signal intensity-modulated in accordance with the frequency-modulated signal. The V-OLT 4 (optical line terminal) may transmit the intensity-modulated optical signal. The V-ONU 6 (optical network unit) may acquire the intensity-modulated optical signal.

Accordingly, even when there is no laser oscillator separate from two laser oscillators for generating a frequency-modulated signal, an intensity-modulated optical signal can be transmitted.

### (Hardware Configuration Example)

A part or all of each functional unit of at least one of the optical transmission system 1a and the optical transmission system 1b is realized as software by having a processor such as a CPU (Central Processing Unit) execute a program stored in a storage apparatus having a non-volatile recording medium (non-transitory recording medium) and a memory. The program may be recorded on a computer-readable recording medium. The computer-readable recording medium is, for example, a non-transitory recording medium such as a portable medium including a flexible disk, a magneto-optical disk, a ROM (Read Only Memory), and a CD-ROM (Compact Disc Read Only Memory), or a storage apparatus such as a hard disk built into a computer system.

A part or all of each functional unit in at least one of the optical transmission system 1a and the optical transmission system 1b may be realized using, for example, hardware including electronic circuits (electronic circuits or circuitry) using an LSI (Large Scale Integrated circuit), an ASIC (Application Specific Integrated Circuit), a PLD (Programmable Logic Device), an FPGA (Field Programmable Gate Array), or the like.

Although embodiments of the present invention have been described in detail with reference to the drawings, specific configurations are not limited to these embodiments, and the present invention also includes designs and the like within a range that does not deviate from the gist of the invention.

### INDUSTRIAL APPLICABILITY

The present invention can be applied to optical transmission systems which generate a frequency-modulated signal using an optical beat.

### REFERENCE SIGNS LIST

1a, 1b Optical transmission system

2 Head-end apparatus

3a, 3b Optical transmission apparatus

4 V-OLT

5 Transmission path

6 V-ONU

7 Display apparatus

10a, 10b Optical transmission apparatus

30a, 30b Frequency modulating unit

31 Intensity modulator

301 First laser oscillator

302 Second laser oscillator

303a, 303b Distributing unit

304 Phase modulator

305 Multiplexing unit

306 Detecting unit

60 Detecting unit

61 Frequency demodulating unit

62 Amplifying unit

100a, 100b Frequency modulating unit

101 First laser oscillator

102 Second laser oscillator

103 Phase modulator

104 Multiplexing unit

105 Detecting unit

106 Amplifying unit

110 Laser oscillator

120 Intensity modulator

1. An optical transmission apparatus, comprising:
a distributing unit which distributes a laser beam based on a first oscillation frequency;
a phase modulator which generates, using the laser beam based on the first oscillation frequency, a phase-modulated signal that is an optical signal phase-modulated in accordance with a modulated signal;
a multiplexing unit which multiplexes a laser beam based on a second oscillation frequency and the phase-modulated signal;
a detecting unit which generates a frequency-modulated signal by performing detection processing on a result of multiplexing of the laser beam based on the second oscillation frequency and the phase-modulated signal; and
an intensity modulator which generates, using the laser beam based on the first oscillation frequency, an optical signal intensity-modulated in accordance with the frequency-modulated signal.

2. (canceled)

3. An optical transmission method executed by an optical transmission apparatus, comprising the steps of:
distributing a laser beam based on a first oscillation frequency;
generating, using the laser beam based on the first oscillation frequency, a phase-modulated signal that is an optical signal phase-modulated in accordance with a modulated signal;
multiplexing a laser beam based on a second oscillation frequency and the phase-modulated signal;
generating a frequency-modulated signal by performing detection processing on a result of multiplexing of the laser beam based on the second oscillation frequency and the phase-modulated signal; and
generating, using the laser beam based on the first oscillation frequency, an optical signal intensity-modulated in accordance with the frequency-modulated signal.

4. (canceled)

5. An optical transmission system comprising an optical transmission apparatus, an optical line terminal, and an optical network unit, wherein the optical transmission apparatus includes:
a distributing unit which distributes a laser beam based on a first oscillation frequency;
a phase modulator which generates, using the laser beam based on the first oscillation frequency, a phase-modulated signal that is an optical signal phase-modulated in accordance with a modulated signal;
a multiplexing unit which multiplexes a laser beam based on a second oscillation frequency and the phase-modulated signal;
a detecting unit which generates a frequency-modulated signal by performing detection processing on a result of multiplexing of the laser beam based on the second oscillation frequency and the phase-modulated signal; and
an intensity modulator which generates, using the laser beam based on the first oscillation frequency, an optical signal intensity-modulated in accordance with the frequency-modulated signal,
the optical line terminal transmits the intensity-modulated optical signal, and
the optical network unit acquires the intensity-modulated optical signal.

6. (canceled)
